(19) United States
(12) Patent Application Publication
(10) Pub. No.: US 2017/0083208 A1
(43) Pub. Date: Mar. 23, 2017

(54) MOBILE TERMINAL AND CONTROL METHOD THEREOF

(71) Applicant: LG ELECTRONICS INC., Seoul (KR)

(72) Inventors: Juha HYUN, Seoul (KR); Yoonseok YANG, Seoul (KR)

(73) Assignee: LG Electronics Inc

(21) Appl. No.: 15/175,186

(22) Filed: Jun. 7, 2016

(30) Foreign Application Priority Data
Sep. 17, 2015 (KR) 10-2015-0131814

(51) Int. Cl. G06F 3/0481; G06F 3/0486; G06F 3/0482; G06F 3/0488

(52) U.S. Cl. CPC G06F 3/04817; G06F 3/0488; G06F 3/0486; G06F 3/0482

(57) ABSTRACT

The present invention relates to a mobile terminal capable of executing various controls related to a folder which manages applications installed at the mobile terminal in an integrated manner, and a control method thereof. The mobile terminal includes a touch screen; and a controller configured to control the mobile terminal based on a touch input applied to the touch screen, wherein the controller controls the touch screen such that at least one icon corresponding to at least one application included in a folder is displayed, in response to a first touch applied to a folder image of the folder in a state where the folder image has been displayed on the touch screen, and wherein the controller controls the touch screen such that screen information related to functions of the applications included in the folder is output, in response to a second touch applied to a predetermined region in a state where the at least one icon has been displayed.

### CROSS-REFERENCE TO RELATED APPLICATION(S)

Pursuant to 35 U.S.C. §119(a), this application claims the benefit of earlier filing date and right of priority to Korean Application No. 10-2015-0131814, filed on Sep. 17, 2015, the contents of which is incorporated by reference herein in its entirety.

### BACKGROUND

1. Field

The present invention relates to a mobile terminal capable of executing various controls related to a folder which manages applications installed at the mobile terminal in an integrated manner, and a control method thereof.

2. Background

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Various attempts have been made to implement complicated functions in such a multimedia device by means of hardware or software.

When applications are installed at the mobile terminal, icons corresponding to the applications are disposed on a home screen page, a menu screen, or a home screen, for access to a corresponding application. In this case, the icons corresponding to the applications may be managed through a folder. If a user selects a folder image (a folder icon), the icons corresponding to the applications included in the folder may be utilized. Such a folder function may be highly utilized, and a method for enhancing a user's convenience may be considered.

### BRIEF DESCRIPTION OF THE DRAWINGS

The embodiments will be described in detail with reference to the following drawings in which like reference numerals refer to like elements wherein:

FIG. 1A is a block diagram for explaining a mobile terminal according to the present invention;

FIGS. 1B and 1C are conceptual views of a mobile terminal according to the present invention, which are viewed from different directions;

FIG. 2 is a flowchart illustrating a method of controlling a folder in a mobile terminal according to the present invention;

FIGS. 3A to 3C are conceptual views illustrating a folder provided in a mobile terminal according to the present invention;

FIGS. 4A to 4H are conceptual views illustrating folder-related functions in a mobile terminal according to the present invention;

FIG. 5 is a conceptual view illustrating a method of providing notification information related to applications included in a folder in a mobile terminal according to the present invention;

FIGS. 6A to 6E are conceptual views illustrating a method of executing different controls based on various touch inputs applied to a folder, in a mobile terminal according to the present invention; and

FIGS. 7A to 7D are conceptual views illustrating a method of controlling applications included in a folder, in a mobile terminal according to the present invention.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

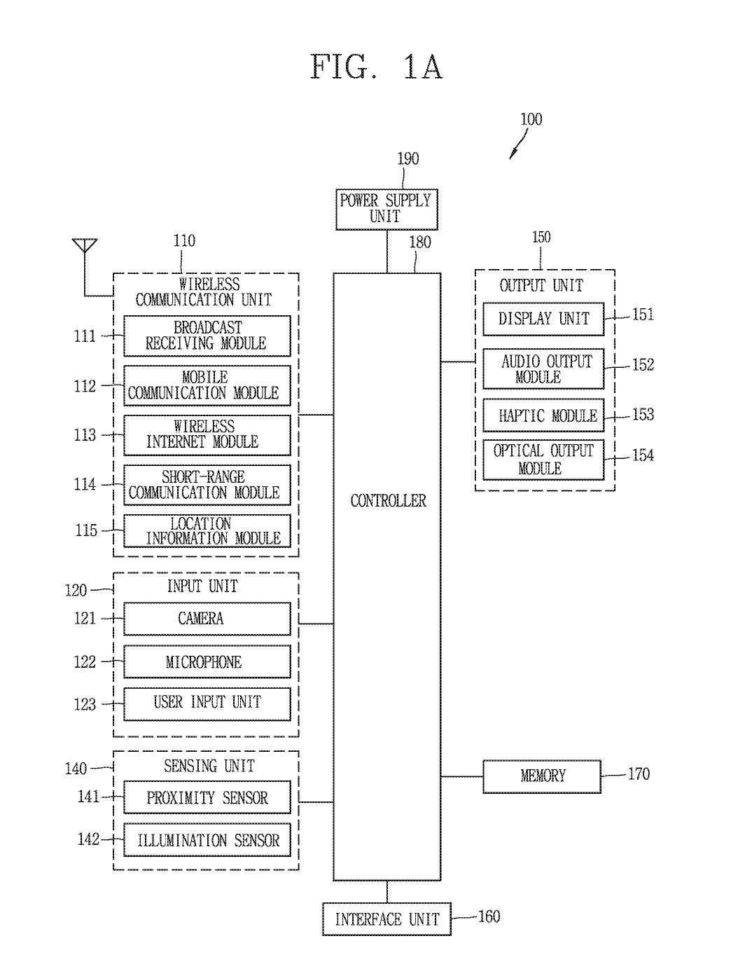

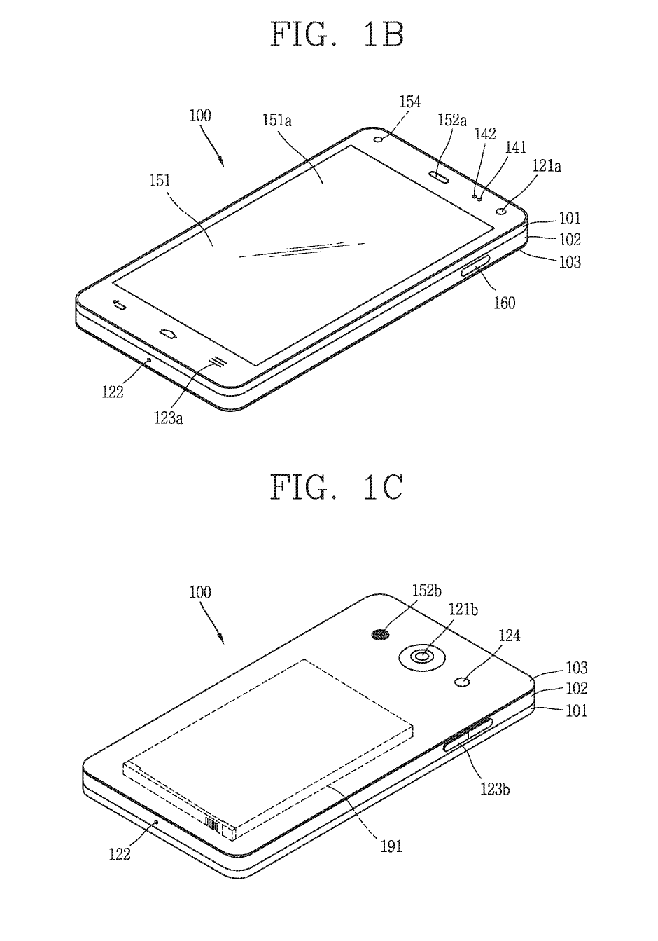

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method for a glass type terminal according to various embodiments to be explained later. The operation or the control method for the glass type terminal may be implemented on the glass type terminal by driving at least one application program stored in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The mobile terminal including at least one of the aforementioned components is provided with a touch screen 151. The touch screen 151 may display various screen information which can be provided from the mobile terminal. Further, a plurality of applications (programs) or software may be installed at the mobile terminal.

For a user's access to the applications installed at the mobile terminal, icons (or graphic objects) corresponding to the applications (or icons which represent the applications) may be output to the touch screen 151. When a specific icon is selected by a user, an application corresponding to the selected icon may be executed. An execution screen of the executed application may be output to the touch screen 151. Such icons may be utilized as a means to apply a user's control command to the mobile terminal.

The icons may be disposed on a home screen page (a standby screen, a menu screen or a home screen, hereinafter will be referred to as ‘home screen page’). At least one of the icons may be grouped by using a folder. More specifically, a folder image (or a folder icon) which represents a folder may be output to a home screen page. When the folder image is selected, one or more icons corresponding to one or more applications included in the folder may be displayed.

In case of constituting the home screen page by utilizing a folder, complexity of the home screen page, which occurs as icons corresponding to applications are disposed on the home screen page, may be reduced. Further, as applications which perform similar functions are included in the same folder by a user's selection or under control of the controller 180, a user's convenience may be enhanced.

The folder described in this specification is used to manage applications installed at the mobile terminal in an integrated manner. In a mobile terminal, a folder may be understood to have one of the following two concepts. Firstly, a folder may be understood to include applications therein. In this case, a folder image corresponding to a specific folder may be displayed on a touch screen. And when the folder image is selected, icons of applications included in the specific folder may be displayed.

Secondly, a folder may be understood to include icons of applications therein, not the applications themselves. In this case, a folder image corresponding to a specific folder may be displayed on a touch screen. And when the folder image is selected, icons included in the specific folder may be displayed. The icons included in the specific folder may be icons which represent applications installed at the mobile terminal.

A folder corresponding to a folder image output to the touch screen 151 of the mobile terminal may contain applications, or icons of the applications. Because detailed features of the present invention to be explained later may be applicable to the aforementioned two concepts of a folder, the two concepts will be explained without any differentiation from each other. Hereinafter, the present invention will be explained based on the concept that a folder includes applications. However, it will be obvious to those skilled in the art that the present invention is also applicable to the concept that a folder includes icons of applications, not the applications themselves.

A method of containing applications or icons of the applications in a folder may be implemented in various manners, and may be modified in various manners. Thus, detailed explanations about the method will be omitted, and the present invention will be explained in an assumption that applications or icons of the applications have been already contained in a folder.

In the mobile terminal according to the present invention, various controls related to a folder may be executed in order to enhance a usability of applications included in the folder and a user's convenience. This will be explained in more detail with reference to the attached drawings, based on the aforementioned folder concept.

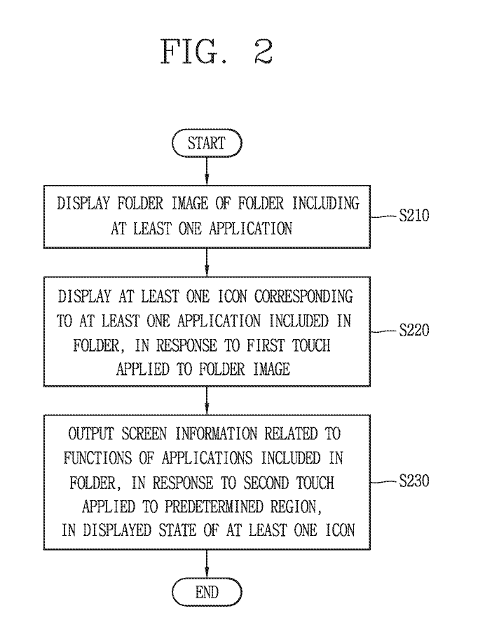

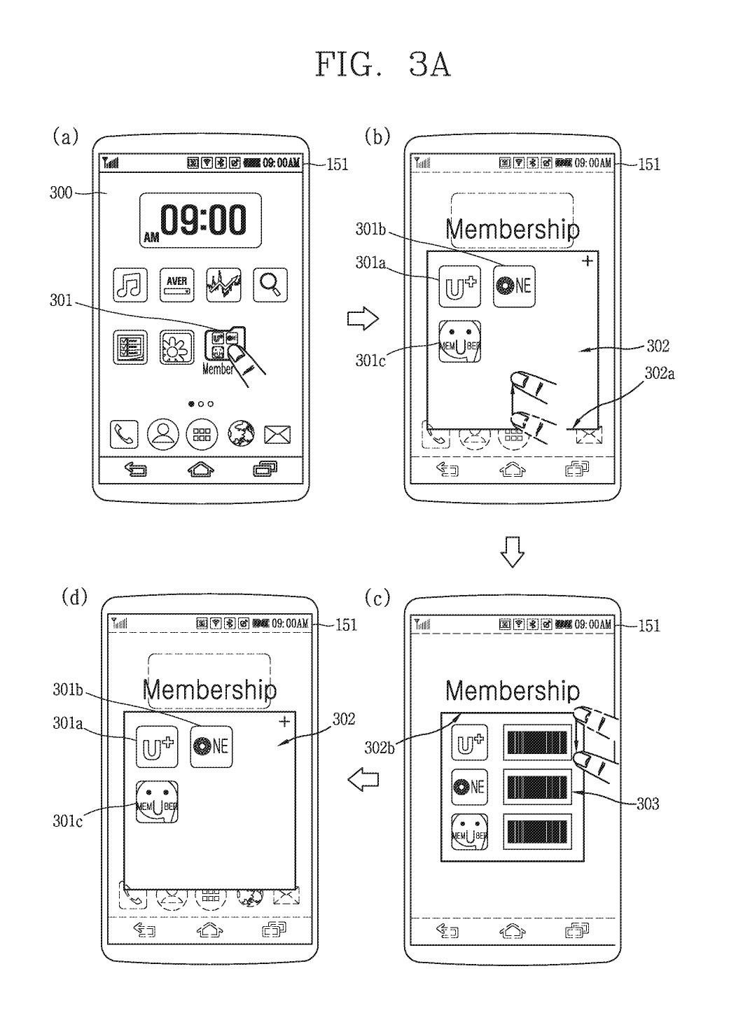

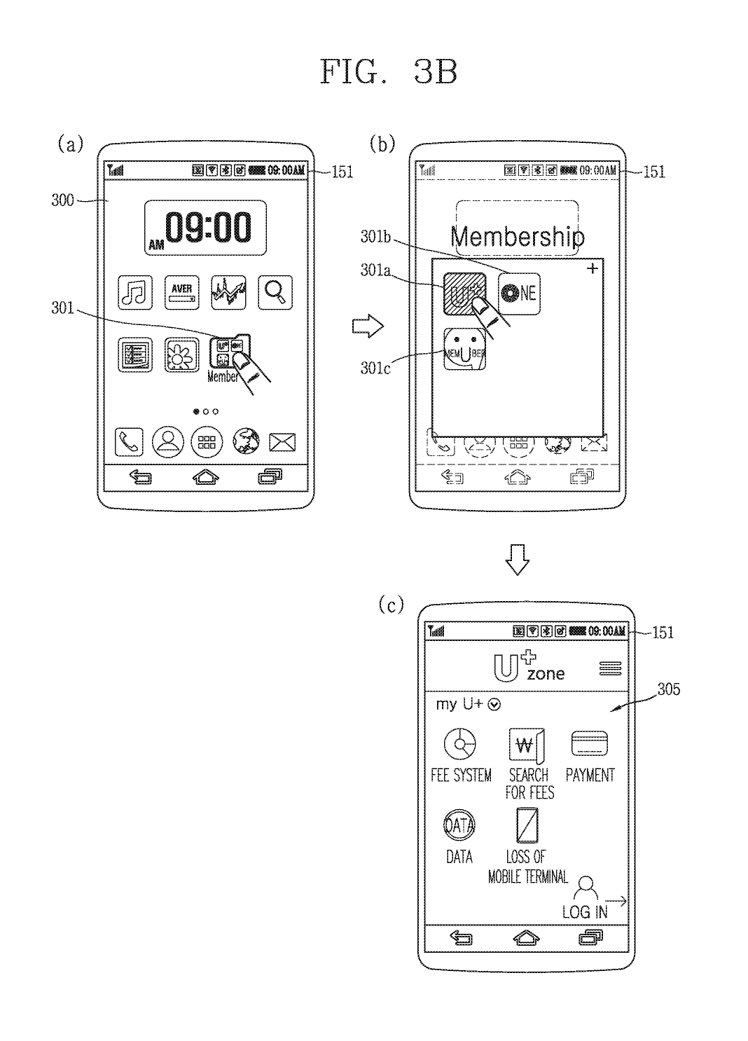

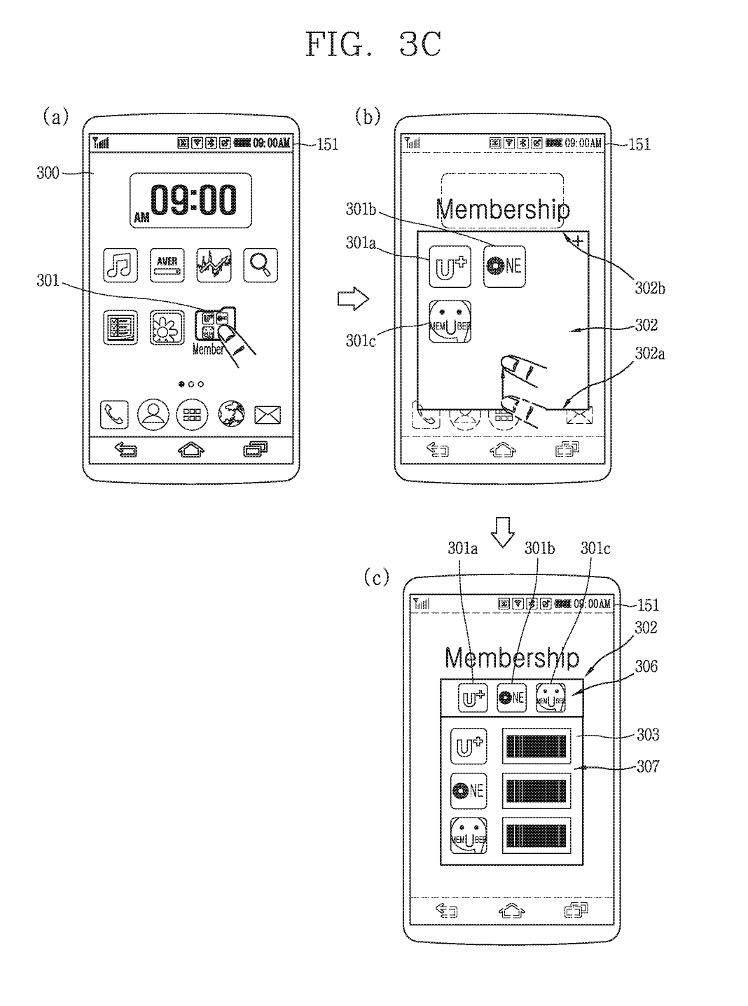

FIG. 2 is a flowchart illustrating a method of controlling a folder in the mobile terminal according to the present invention, and FIGS. 3A to 3C are conceptual views illustrating a folder provided in the mobile terminal according to the present invention.

In the mobile terminal according to the present invention, an image of a folder including at least one application is displayed (S210). As shown in FIG. 3A(a), the folder image may be included in a home screen page 300. The home screen page 300 may include at least one of an icon of an application, a widget and a folder image. FIG. 3A(a) illustrates the home screen page 300 including a single folder image 301, a plurality of application icons and a plurality of widgets.

After the folder image has been displayed in S210, if a first touch input is applied to the folder image, at least one icon corresponding to at least one application included in a folder corresponding to the folder image is displayed (S220). More specifically, if the folder image 301 is selected based on a first touch as shown in FIG. 3A(a), the controller 180 displays application icons 301a, 301b, 301c included in the folder, on at least one region of the touch screen.

When the folder image 301 is selected, a window (a pop-up window 302 or a folder window 302) including the application icons 301a, 301b, 301c included in the folder may be output as shown in FIG. 3A(b). That is, if the folder image 301 is selected, the controller 180 may output the window 302 or the pop-up window including the application icons 301a, 301b, 301c included in the folder.

The window 302 may be displayed on a partial region or an entire region of the touch screen 151.

The first touch, a touch having a predetermined type, may be a short-touch. The predetermined type of the first touch may be modified in various manners.

As aforementioned, if the folder image 301 is selected, the application icons 301a, 301b, 301c included in the folder are displayed. Then, if a second touch is applied to a preset region of the touch screen 151, screen information about functions of the applications included in the folder is output (S230).

As shown in FIG. 3A(b), the preset region may be one edge region 302a of the window 302 including the application icons 301a, 301b, 301c contained in the folder. For instance, if a second touch is applied to the one edge region 302a of the window 302 as shown in FIG. 3A(b), the controller 180 may output screen information 303 about functions of the applications included in the folder, as shown in FIG. 3A(c).

The second touch may be a touch having a predetermined type. Alternatively, the second touch may be the same touch as the aforementioned first touch, or may be a different touch from the aforementioned first touch. For instance, the second touch may be a drag touch starting from the one edge region 302a as shown in FIG. 3A(b).

If the first touch is applied to the folder image 301, the controller 180 may output the window 302 including the application icons 301a, 301b, 301c contained in the folder, to at least one region of the touch screen. And if the second touch is applied to the output region of the window 302 (or a preset region), the controller 180 may control the screen information to be displayed on the touch screen.

In this case, if the second touch is a drag touch starting from the one edge region 302a (the first edge region 302a), the controller 180 may control the touch screen 151 such that the screen information 303 may gradually appear from the one edge region 302a of the window 302 along the drag touch. If a length of the drag touch satisfies a preset condition, even if the drag touch is released, the screen information 303 may be continuously output. In this case, the screen information 303 may be entirely displayed. On the other hand, if the length of the drag touch does not satisfy the preset condition, the screen information 303 may gradually appear along the drag touch. Then, when the drag touch is released, the screen information 303 may disappear. As shown in FIG. 3A(c), the screen information 303 may be output within the window 302. The screen information 303 may be output to the touch screen 151 in various manners.

Although not shown, the preset region may be a region corresponding to one edge of the touch screen 151. In this case, the controller 180 may control the touch screen 151 such that the screen information 303 may be output based on a drag touch starting from one edge of the touch screen 151. The position of the preset region may be modified in various manners.

Screen information output in response to the second touch is related to functions of applications included in a folder, and may be configured in various manners.

For instance, the screen information may be at least one of (i) widgets provided from applications included in a folder, (ii) graphic objects corresponding to execution screens of the applications included in the folder, (iii) information about a representative function of each of the applications included in the folder, (iv) screen information about a common function of the applications included in the folder, (v) an image (or a captured image) related to at least one of the applications included in the folder, and (vi) a web page (or a bookmarked web page) related to the applications included in the folder. The screen information may be implemented in various manners.

A type of the screen information may be determined based on at least one of a type of applications included in a folder, and functions of the applications. Alternatively, a type of the screen information may be determined according to a user's selection or under control of the controller. Still alternatively, a type of the screen information may be determined based on a type of a second touch applied to the touch screen or the window 302, which will be explained in more detail.

For instance, FIG. 3A illustrates that membership-related applications are included in a folder. Each of the membership-related applications may provide a function related to point accumulation with respect to a specific brand. More specifically, the membership-related applications provide barcode images such that points are accumulated on a user's account.

In a case where such membership-related applications are included in a specific folder, the controller 180 may provide at least part of barcode images provided from the applications, as the screen information 303 as shown in FIG. 3A(c).

In this case, a user may execute a function of a specific application, without executing the specific application by selecting an icon of the specific application. In this case, a bar code image provided as the screen information 303 may be a widget.

In the case where the screen information 303 has been output, each application included in the folder related to the screen information 303 may be in an executed state. In this case, each application may be in an executed state on a background, and the controller 180 may constitute the screen information 303 by extracting information from each of the executed applications. In this case, the controller 180 may execute non-executed applications among the applications included in the folder, in response to the second touch for outputting the screen information 303.

As another example, when an output of the screen information 303 is requested, the controller 180 may not execute the applications included in the folder. In this case, the controller 180 may pre-store the screen information 303 in the memory 170. Once a folder is generated and applications are included in the folder, the controller 180 may constitute the screen information 303 in advance to store the screen information 303 in the memory 170.

In a state where the screen information 303 has been displayed, as shown in FIGS. 3A(c) and 3A(d), the controller 180 may control the screen information 303 to disappear, based on a touch (e.g., a drag touch) applied to another edge region 302b (the second edge region 302b) of the window 302 including the application icons 301a, 301b, 301c contained in the folder. In this case, the controller 180 may control the touch screen 151 such that the screen information 303 may gradually disappear based on a drag touch applied to the another edge region 302b.

Although not shown, the screen information 303 may disappear when a preset type of touch (e.g., a short-touch) is applied to a region of the touch screen 151 where the window 302 has not been output.

That is, the touch screen 151 may be divided into a first region where the window 302 has been output, and a second region where the window 302 has not been output. If a preset type of touch is applied to the second region, the controller 180 may control the screen information 303 to disappear.

In this case, information, which was being output before the screen information 303 is output, may be displayed on the touch screen 151. The information may include the application icons 301a, 301b, 301c included in the folder.

Alternatively, if the screen information 303 disappears, the application icons 301a, 301b, 301c included in the folder and the window 302 may not be output any longer.

As shown in FIGS. 3A(a) and 3A(b), in a state where the window 302 including the application icons 301a, 301b, 301c included in the folder has been output based on a first touch applied to the folder image 301, a third touch may be applied to the icon 301a included in the window 302. In this case, as shown in FIG. 3B(c), the controller may control the touch screen 151 such that an execution screen 305 of an application corresponding to the icon 301a to which the third touch has been applied may be output in the form of an entire screen. In this case, if the application corresponding to the icon 301a to which the third touch has been applied is in a non-executed state, the controller 180 may execute the application corresponding to the icon 301a to which the third touch has been applied. Then, the controller 180 may output an execution screen. The third touch is a preset type of touch, which may be a short-touch. The type of the third touch may be modified in various manners. Icon selection based on the third touch may be also executable for the operations shown in FIG. 3A(d).

Unlike in FIG. 3A, if a second touch is applied to the one edge region 302a of the window 302 as shown in FIGS. 3C(a) and 3C(b), the screen information 303 may be output together with the application icons 301a, 301b, 301c included in the folder as shown in FIG. 3C(c). That is, in the aforementioned embodiment, only the screen information 303 is output based on the second touch, in a state where the application icons 301a, 301b, 301c included in the folder are not output. However, in this embodiment, as shown in FIG. 3C(c), the screen information 303 may be output together with the application icons 301a, 301b, 301c included in the folder. In this case, the window 302 may include a plurality of regions 306, 307. The application icons 301a, 301b, 301c included in the folder may be output to the one region 306, and the screen information 303 may be output to the another region 307.

Even if the second touch is applied, the controller 180 may maintain the displayed state of the at least one icon corresponding to the at least one application included in the folder.

In the present invention, only the operations shown in FIGS. 3C(a) and 3C(c) may be executed without the operations shown in FIG. 3C(b). That is, if the specific folder image 301 is selected based on a first touch as shown in FIG. 3C(a), the controller 180 may output the screen information 303 together with the application icons 301a, 301b, 301c included in the folder. As shown in FIG. 3C(c), the application icons 301a, 301b, 301c included in the folder may be output to the one region 306, and the screen information 303 may be output to the another region 307.

As aforementioned, the screen information 303 may be at least one of (i) widgets provided from applications included in a folder, (ii) graphic objects corresponding to execution screens of the applications included in the folder, (iii) information about a representative function of each of the applications included in the folder, (iv) screen information about a common function of the applications included in the folder, (v) an image (or a captured image) related to at least one of the applications included in the folder, and (vi) a web page (or a bookmarked web page) related to the applications included in the folder. The screen information may be implemented in various manners.

As aforementioned, in the mobile terminal and the control method thereof according to the present invention, when a specific folder is selected, a functional screen related to applications included in the specific folder may be provided. With such a configuration, a user may be provided with a desired function by merely selecting the specific folder, without selecting an icon of an application included in the specific folder in order to be provided with a function of the application. This may allow the user to check functions of the applications included in the folder more rapidly, in an intuitive manner.

Hereinafter, examples of screen information provided when a folder image is selected will be explained in more detail with reference to the attached drawings.

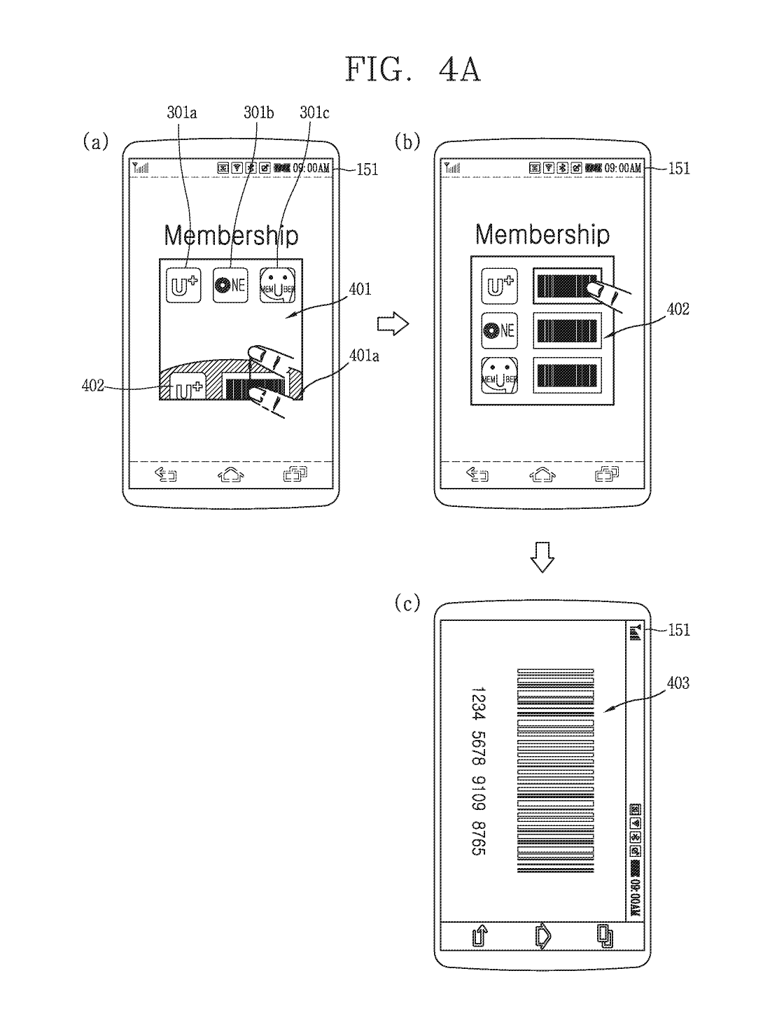

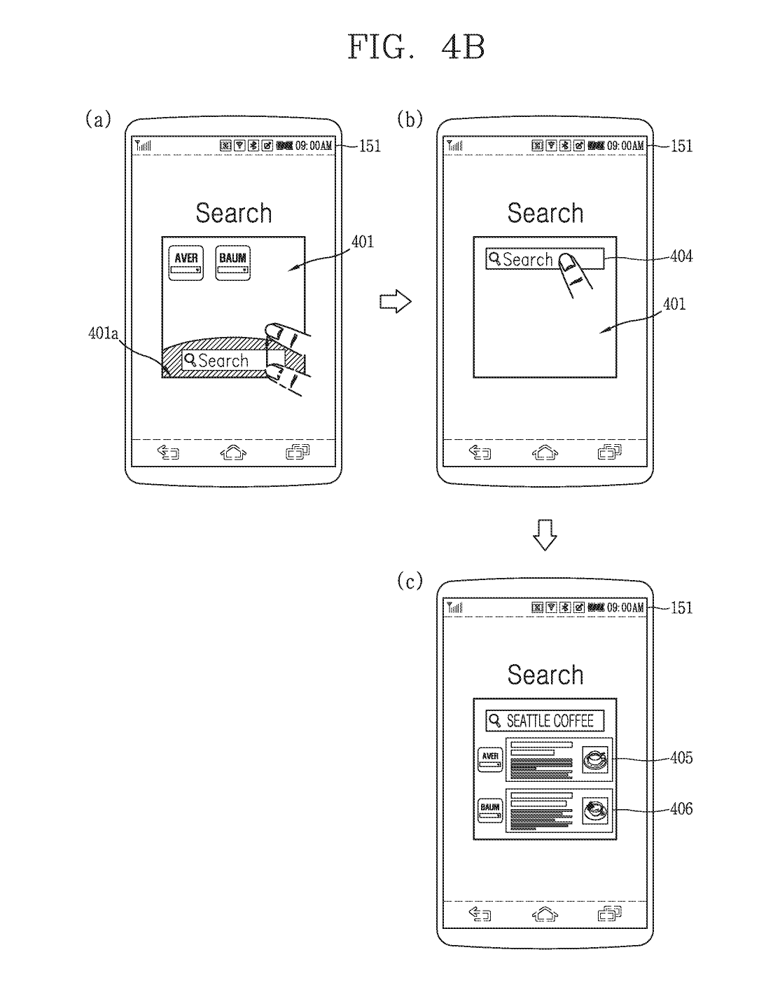

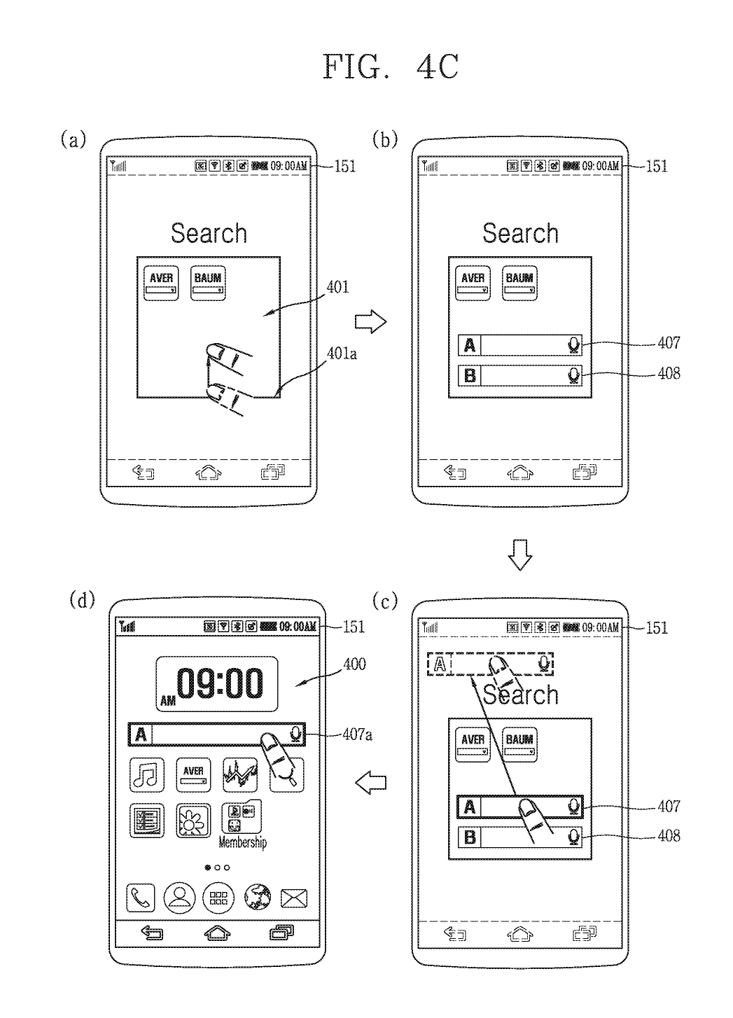

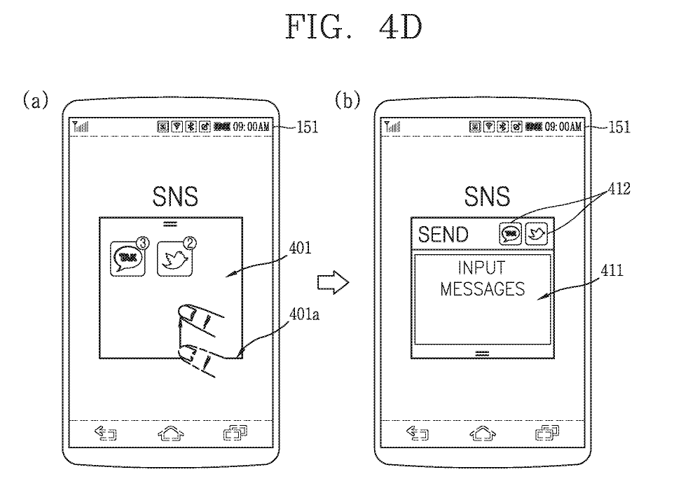

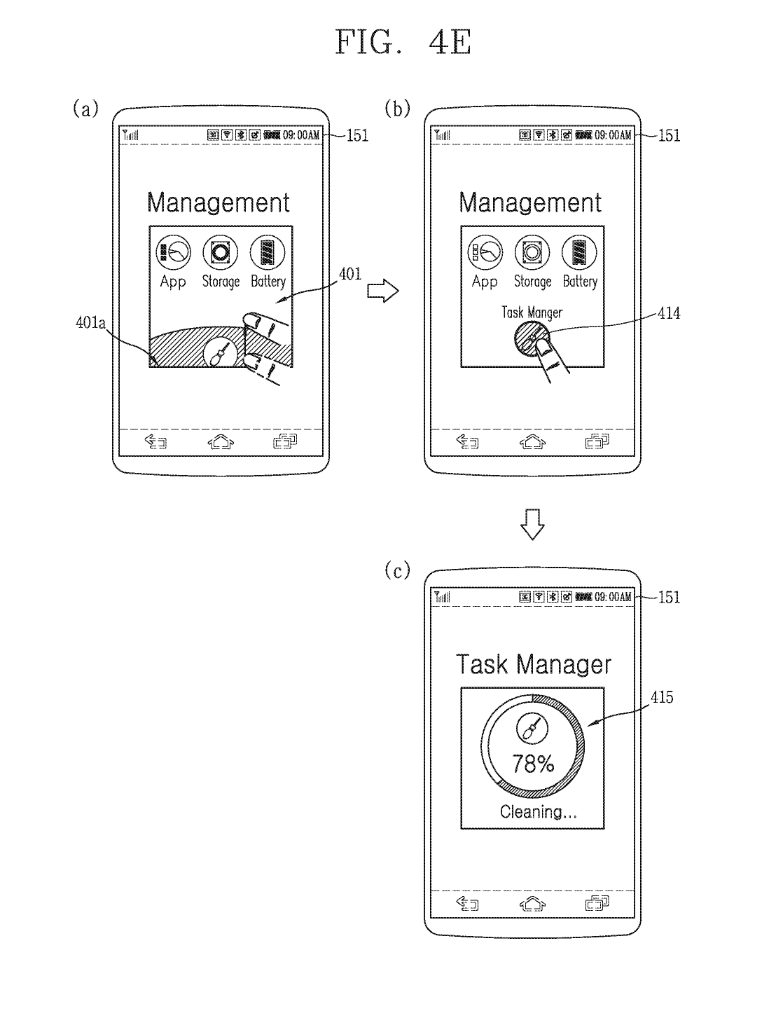

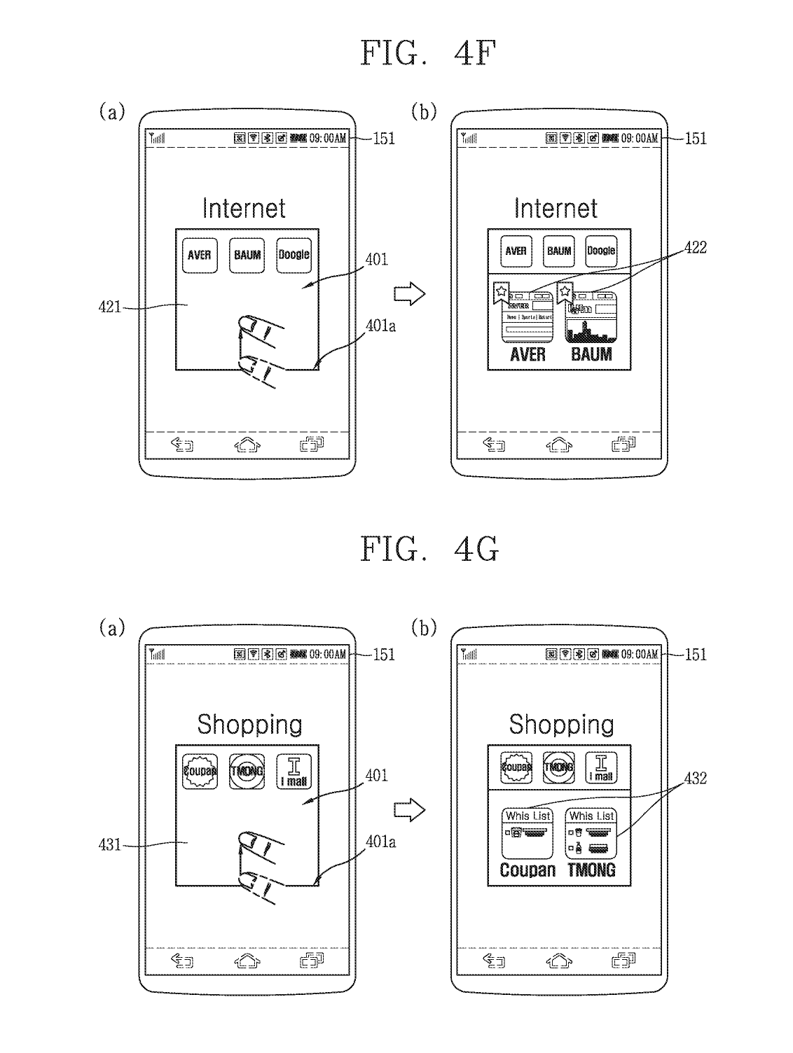

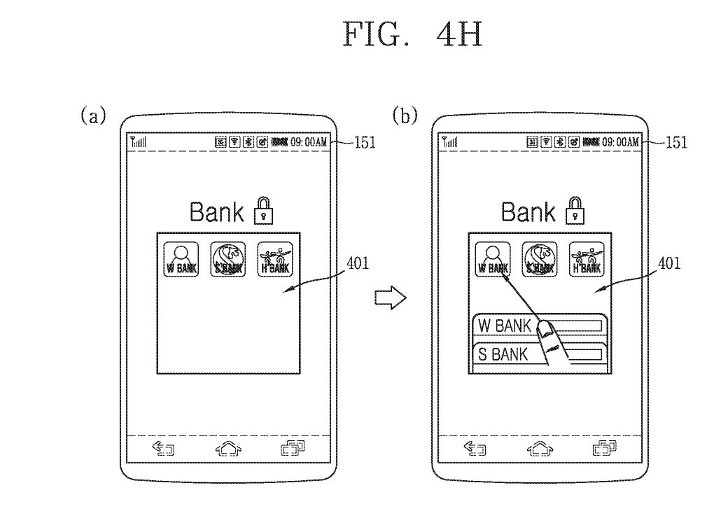

FIGS. 4A to 4H are conceptual views illustrating folder-related functions in the mobile terminal according to the present invention.

Part of FIGS. 4A to 4H illustrates that icons of applications included in a folder are output when a folder image is selected, like in FIG. 3A(a).

For instance, referring to FIG. 4A, if membership-related applications are included in a folder, the controller 180 may provide at least part of barcode images provided from the applications included in the folder, as screen information 403, based on a touch input applied to a preset region of the touch screen 151 (e.g., one edge region 401a of a window 401 (a folder window).

In this case, a user may execute a function of a specific application, without executing the specific application by selecting an icon of the specific application included in the folder. A barcode image provided as the screen information 403 may be a widget. If one of barcode images is selected as shown in FIG. 4A(b), the controller 180 may output the screen information 403 related to the selected barcode image. The screen information 403 related to the selected barcode image may be an enlarged image of the selected barcode, or may be an execution screen of an application corresponding to the selected barcode. In this case, the screen information 403 related to the selected barcode image may be output in the form of an entire screen.

As another example, referring to FIG. 4B, if search function-related applications are included in a folder, the controller 180 may output a graphic object 404 related to a search function as screen information, based on a touch input applied to a preset region of the touch screen 151 (e.g., one edge region 401a of the window 401, as shown in FIGS. 4B(a) and 4B(b). The graphic object 404 may include a search word input region. If the graphic object 404 is selected, the controller 180 may output a virtual keyboard, or may receive a search word from a user by activating a voice input function. Once the search word is input, the controller 180 may display a search result as shown in FIG. 4B(c). The search result may be obtained through the search function-related applications included in the folder. That is, the controller 180 may perform search with respect to the search word input to the search word input region, through search engines corresponding to the applications included in the folder. And the controller 180 may output a search result obtained through the search engines, to one region of the touch screen. With such a configuration, a user may be provided with a single integrated search result, without having a difficulty in performing search by directly entering each application.

The graphic object 404 may be a type of widget. In this case, each application may be in an executed state on a background. And the controller 180 may perform search through each of the executed applications, and may output a search result. If there is a search request through the graphic object 404, the controller 180 may execute non-executed applications among the applications included in the folder.

As another example, referring to FIG. 4C, if search function-related applications are included in a folder, the controller 180 may output widgets 407, 408 corresponding to the search function-related applications as screen information, based on a touch input applied to a preset region of the touch screen 151 (e.g., one edge region 401a of the window 401, as shown in FIGS. 4C(a) and 4C(b). If one of the widgets 407, 408 is selected, the controller 180 may execute search through the selected widget. In this case, the controller 180 may execute search through an application corresponding to the selected widget. A search result may be provided like in FIG. 4B. In this case, the application corresponding to the selected widget, among the applications included in the folder, may be in an executed state on a background. The controller 180 may perform search through the executed application, and may output a search result. In a case where there is a search request through the selected widget, the controller 180 may execute the application corresponding to the selected widget, if the application is in a non-executed state.

As another example, if one widget 407 is selected by a preset type of touch (e.g., a drag touch starting from the one widget 407) as shown in FIG. 4C(c), the controller 180 may arrange the selected widget on a home screen page 400 as shown in FIG. 4C(d).

As another example, referring to FIG. 4D, if applications related to social network service (SNS) functions or messenger functions are included in a folder, the controller 180 may output a graphic object 411 for a message inputting function as screen information, based on a touch input applied to a preset region of the touch screen 151 (e.g., one edge region 401a of the window 401), as shown in FIGS. 4D(a) and 4D(b). A user may send a message or may update a new message by utilizing the graphic object 411, without directly entering a specific application. In this case, the controller 180 may send (or upload) content input through the graphic object 411, to servers corresponding to the applications included in the folder, another mobile terminal, or service. Alternatively, the controller 180 may send content input through the graphic object 411, to a server corresponding to an application selected by a user among the applications included in the folder, another mobile terminal, or service.

As another example, referring to FIG. 4E, if applications for entirely managing the mobile terminal (e.g., storage management, application management, battery management, etc.) are included in a folder, the controller 180 may output a graphic object for managing an application being executed or a graphic object 414 for managing storage (memory) of the mobile terminal, as screen information, based on a touch input applied to a preset region of the touch screen 151 (e.g., one edge region 401a of the window 401), as shown in FIGS. 4E(a) and 4E(b). If the graphic object 414 is selected, the controller 180 may terminate an application being currently executed, or may execute a function to optimize a memory usage amount as shown in FIG. 4E(c). In this case, the function may be executed through the application included in the folder.

As another example, referring to FIG. 4F, if applications related to an Internet browser or a web browser are included in a folder, the controller 180 may output graphic objects 422 (or thumbnails) corresponding to bookmarked websites on the applications, as screen information, based on a touch input applied to a preset region of the touch screen 151 (e.g., one edge region 401a of the window 401), as shown in FIGS. 4F(a) and 4F(b). If one of the graphic objects is selected, the controller 180 may output a web site corresponding to the selected graphic object, through the application included in the folder. In this case, an application, to which the selected graphic object has been bookmarked, may be executed.

In this case, a graphic object corresponding to a frequently-visited web site may be output as the screen information.

As another example, referring to FIG. 4G, if shopping-related applications are included in a folder, the controller 180 may output graphic objects 432 (or thumbnails) corresponding to a shopping basket screen or a wish list screen of each application, as screen information, based on a touch input applied to a preset region of the touch screen 151 (e.g., one edge region 401a of the window 401), as shown in FIGS. 4G(a) and 4F(b). If one of the graphic objects 432 is selected, the controller 180 may output an execution screen of an application corresponding to the selected graphic object. In this case, captured images of the shopping-related applications may be output as the screen information. Alternatively, other shopping-related image may be also output as the screen information.

As another example, referring to FIG. 4H, if applications related to Internet banking or mobile banking are included in a folder, the controller 180 may output security card images related to the applications included in the folder, as screen information, based on a touch input applied to a preset region of the touch screen 151 (e.g., one edge region 401a of the window 401), as shown in FIGS. 4H(a) and 4H(b). If one of the images is selected, the controller 180 may output the selected image in the form of an entire screen. As another example, if one of the images is selected, the controller 180 may output the selected image to one region, and may output an execution screen of an application corresponding to the selected image to another region. In this case, a user may conveniently perform a banking operation with viewing a security card.

In the aforementioned embodiments, if screen information to be output is not output to a single screen, the controller 180 may output the non-output screen information based on a touch input applied to the touch screen 151.

As aforementioned, in the mobile terminal of the present invention, various screens may be configured according to a type of applications included in a folder. Further, in the mobile terminal of the present invention, a user may select screen information or a function through a folder.

Hereinafter, a method of managing events occurring from applications included in a folder, in an integrated manner will be explained in more detail with reference to the attached drawings.

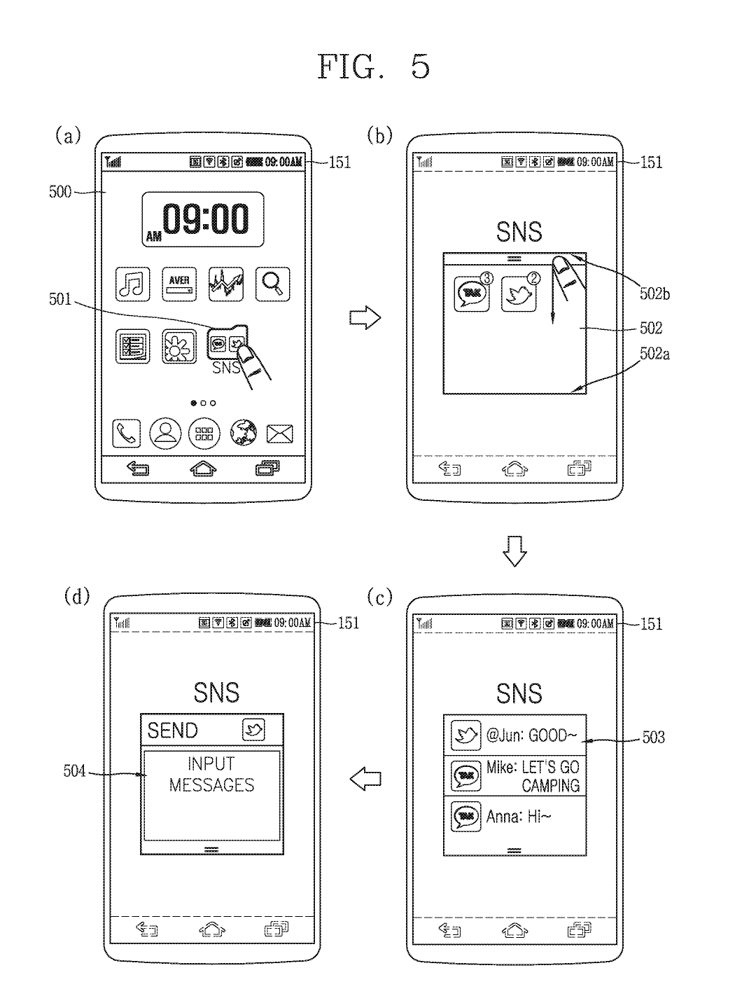

FIG. 5 is a conceptual view illustrating a method of providing notification information related to applications included in a folder in a mobile terminal according to the present invention.

Referring to FIGS. 5a and 5b, in a state where a window 502 corresponding to a folder (or a folder window) has been output, a preset type of touch may be applied to a preset region of the window 502 or a preset region of the touch screen 151. In this case, event information 503 related to events occurring from applications included in the folder may be output.

The event information may be implemented in various manners. More specifically, the event information may be a message received from an application-related server, a push message, a message received from an external terminal through an application, information occurring based on an operation of an application, etc. For instance, in case of a message application, the event information may be a message received from another party. In case of a schedule application, the event information may be schedule information corresponding to a current date.

The event information 503 may be output in the form of a list. The list may include at least one item corresponding to different event information. If one of items included in the list is selected, the controller 180 may output an execution screen of an application corresponding to the selected item. In this case, the execution screen may include event information corresponding to the selected item.

As another example, if one of the items is selected, the controller 180 may output screen information 504 for a function related to an event corresponding to the selected item (e.g., a reply function).

The event information may be output within the folder window 502. If part of the event information has been output to the window 502, a scroll bar may be output. In this case, a non-output part of the event information may be sequentially output by a user's selection.

As shown in FIG. 5b, if no event occurs from the applications included in the folder, even if a touch input for outputting event information has been applied, the controller 180 may not output event information. In this case, the controller 180 may output notification information indicating non-occurrence of event information, in at least one of visual, tactile, and audible manners.

An indicator indicating occurrence of event information may be output to one region of a folder image including an application from which the event information has occurred. And the indicator indicating occurrence of event information may be output to an icon of an application from which the event information has occurred. As aforementioned, if event information is output to a folder window, the controller 180 may not output the indicator any longer, by determining that the event information has been confirmed.

If a user inputs an event information confirmation signal in a state where the event information has been output to the folder window, (e.g., if the event information confirmation signal may be received as the user applies a preset type of touch to each item, or as the user touches an event confirmation icon included in each item), the controller 180 may determine that the event information has been confirmed by the user. In this case, an item corresponding to the event confirmed by the user may disappear from the touch screen 151. And an indicator related to the event confirmed by the user, among the indicators, may disappear.

If an event is checked by a user, an indicator related to the checked event, which has been output to a space including status information about an entire operation of the mobile terminal or status information of the mobile terminal (e.g., a status display region, a status display bar or a status window (a notification window or a curtain window)), may disappear.

In the mobile terminal according to the present invention, as aforementioned, if a preset type of touch is applied to a folder window, screen information related to applications included in a folder may be provided, and event information about events generated from the applications may be provided in an integrated manner.

That is, the controller 180 may provide event information about events generated from applications included in a folder, on a folder window, without directly entering an event-occurred application. In the mobile terminal, such an event information providing function may be implemented together with the aforementioned function which provides screen information related to applications included in a folder.

Alternatively, one of the event information providing function and the function which provides screen information related to applications included in a folder may be implemented.

If the event information providing function and the function which provides screen information related to applications included in a folder are provided together, the controller 180 may provide the functions based on preset type of touches applied to different regions of the folder window 502. For instance, as shown in FIG. 5b, if a preset type of touch is applied to a first edge region 502a of the folder window 502, the controller 180 may provide screen information as aforementioned with reference to FIGS. 2, 3A˜3B, and 4A˜4H. On the other hand, if a preset type of touch is applied to a second edge region 502b of the folder window 502, the controller 180 may provide event information.

The controller 180 may execute a different function based on a different type of touch applied to the window 502, or based on a different type of touch applied to the touch screen 151 in an output state of the window 502.

As aforementioned, in the mobile terminal according to the present invention, if a folder is selected, event information about events generated from applications included in the folder is provided. This may allow a user to access the event information more rapidly in an intuitive manner.

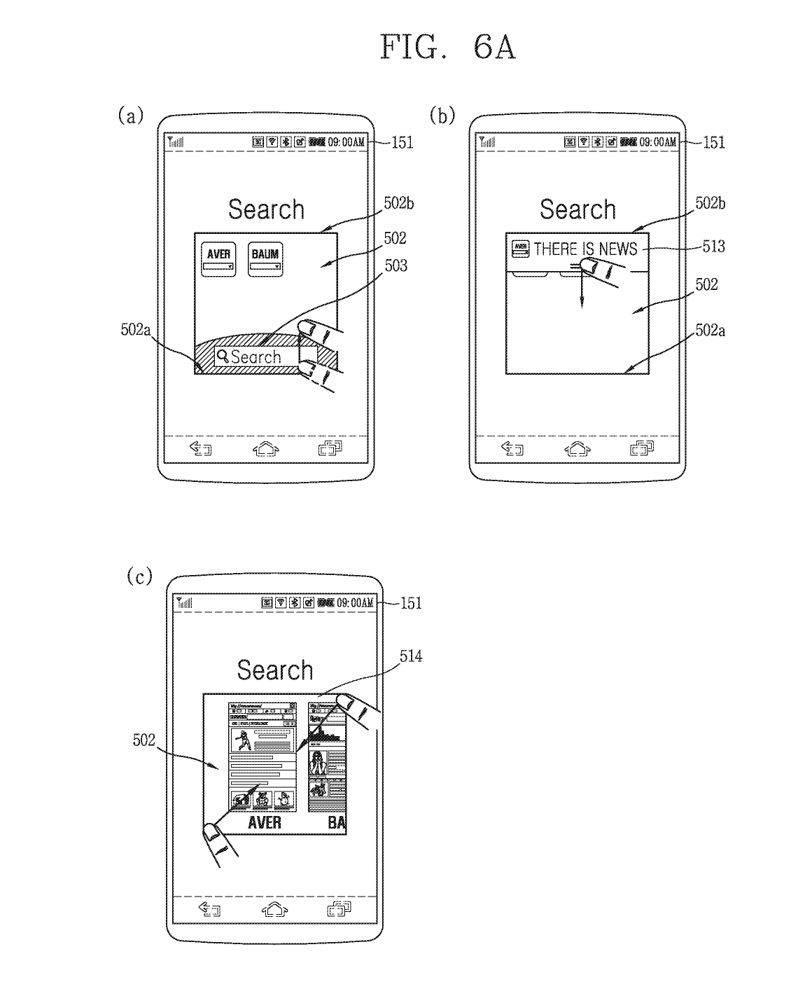

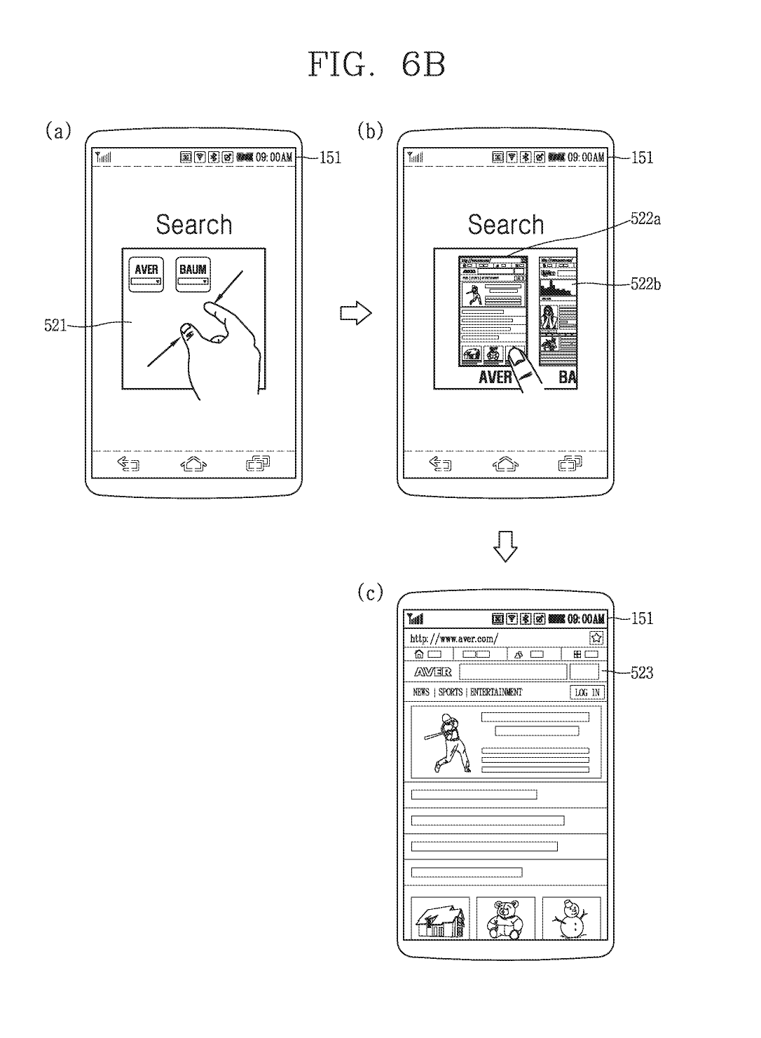

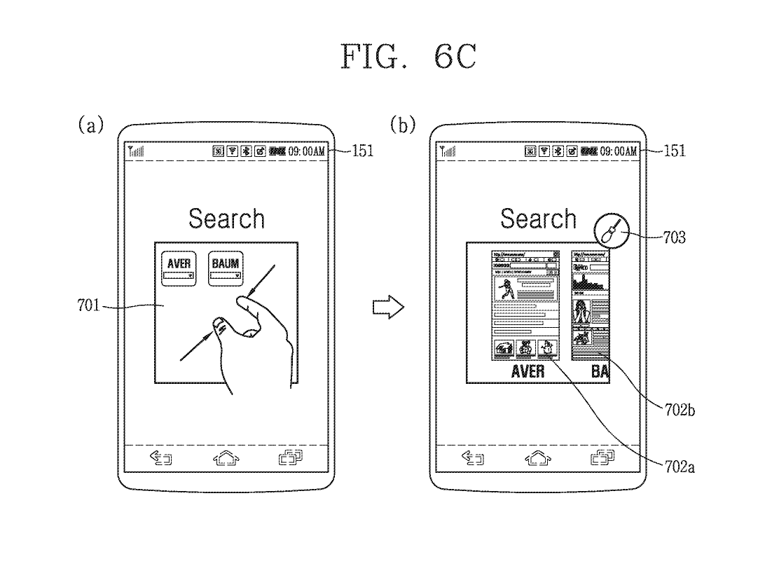

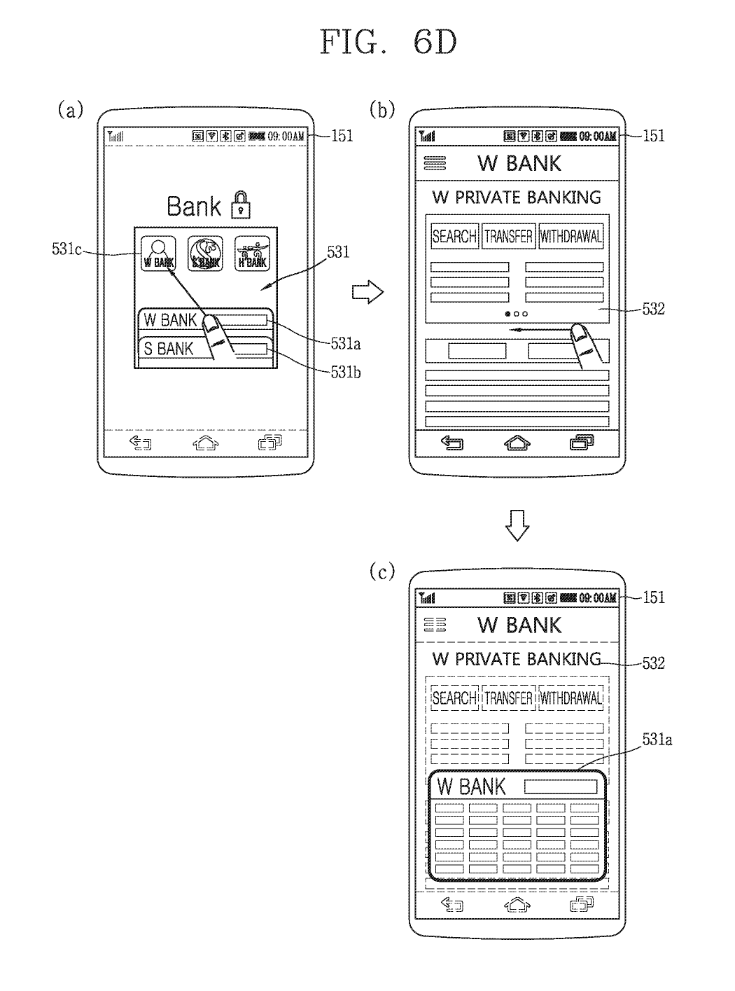

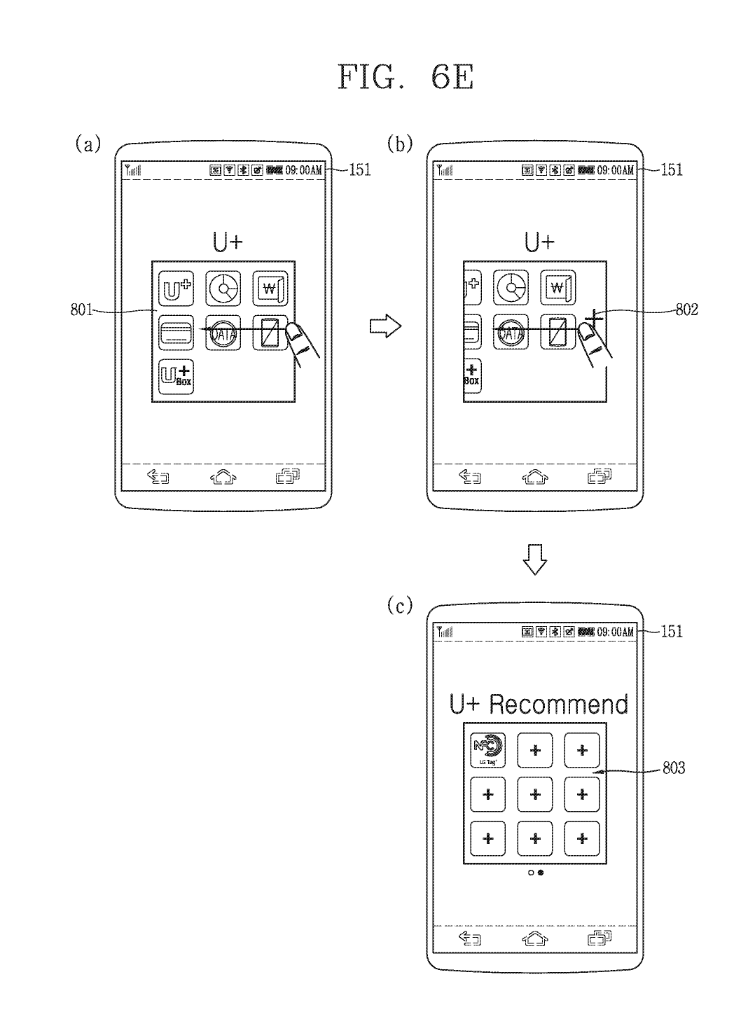

In the mobile terminal according to the present invention, different screen information related to applications included in a folder may be output, if different regions of a folder window are touched, or if different types of touches are applied to the folder window. With such a configuration, a user may access various screen information related to the applications included in the folder, more rapidly. This will be explained in more detail with reference to the attached drawings. FIGS. 6A to 6E are conceptual views illustrating a method of executing different controls based on various touch inputs applied to a folder, in the mobile terminal according to the present invention.

As shown in FIG. 6A, if a preset type of touch is applied to a first edge region 502a of a window 502 including icons of applications included in a folder, a first function (e.g., screen information related to functions of the applications included in the folder). On the other hand, if a preset type of touch is applied to a second edge region 502b of the window 502, a second function different from the first function (e.g., a function to display event information about events occurring from the applications included in the folder) may be executed. The controller may output different screen information related to the applications included in the folder, according to a region of the window 502 to which a preset type of touch has been applied.

As shown in FIG. 6A(c), the controller 180 may execute a third function based on a touch input applied to the window 502, or based on a touch input applied to the touch screen 151 in an output state of the window 502. The third function may be a function to output a graphic object 514 corresponding to an execution screen of each of the applications included in the folder. The execution screen may be a screen which has been output most recently from each of the applications included in the folder. That is, the graphic object may include information about an execution screen which has been output most recently from each of the applications included in the folder.

The preset type of touch is a pinch-out touch applied to the window 502 or the touch screen 151. And the controller 180 may output a graphic object corresponding to an execution screen of each of the applications included in the folder, in response to the pinch-out touch. If a pinch-in touch is applied in the output state of the graphic object, the controller 180 may control the graphic object to disappear.

All of the first to third functions corresponding to FIGS. 6A(a)˜6A(c) may be applied to the mobile terminal. Alternatively, at least one or at least two of the first to third functions may be applied to the mobile terminal.

As shown in FIGS. 6B(a) and 6B(b), in an output state of graphic objects 522a, 522b corresponding to execution screens of applications included in a folder, if one of the graphic objects 522a, 522b is selected (touched) by a preset type of touch, the controller 180 may output an execution screen 523 of an application corresponding to the selected graphic object 522a, as shown in FIG. 6B(c). The application may be in an executed state. If the application is in a non-executed state before the graphic object 522a is selected, the controller 180 may execute the application when the graphic object 522a is selected. The execution screen 523 may be output in the form of an entire screen.

As shown in FIGS. 6C(a) and 6C(b), if a preset type of touch (e.g., a pinch-in touch) is applied, the controller 180 may output graphic objects 702a, 702b corresponding to execution screens of applications included in a folder, and may output a graphic object 703 for an additional function. The additional function corresponding to the graphic object 703 may be a function to terminate an executed state of the applications included in the folder, or a function to optimize a memory usage amount related to the applications included in the folder.

As another example, as shown in FIG. 6D(a), if a touch input is applied by a user, at least one of screen information 531a, 531b output in relation to applications included in a folder may be correlated to a specific application included in the folder (e.g., an application corresponding to an icon 531c). For instance, if one of the screen information 531a, 531b is dragged to the icon 531c of the specific application by a user and then the user's drag touch is released, the controller 180 may correlate the specific application with the one screen information 531a.

Referring to FIG. 6D(b), if the specific application is executed by a user's selection, the controller 180 may re-output the selected screen information 531a, based on a subsequent touch input of the user. For instance, if a preset type of touch (e.g., a drag touch input toward one direction) is applied in an output state of an execution screen 532 as shown in FIG. 6D(b), the controller may output the screen information 531a as shown in FIG. 6D(c). The screen information 531a may be output in an overlapped manner with the execution screen 532.

As another example, if the drag touch input toward one direction is applied, the controller 180 may output the screen information 531a to one region of the touch screen, and may output an execution screen of an application to another region of the touch screen.

In a case where the application is an application related to Internet banking or mobile banking and the screen information is a security card image, a user may conveniently perform a banking operation with viewing the security card.

As another example, if a preset type of touch (e.g., a drag touch input toward one direction) is applied in an output state of a folder window 801 as shown in FIG. 6E(a), the controller may output a graphic object 802 for adding an application, to the folder window 801 as shown in FIG. 6E(b). If the graphic object 802 is selected by a user, the controller 180 may output information 803 related to one or more recommended applications.

The one or more recommended applications may be applications pre-installed at the mobile terminal, not applications included in a folder corresponding to the folder window 801. In this case, if a user selects for the information 803 related to one or more recommended applications, at least one of the one or more recommended applications may be included in the folder.

The one or more recommended applications may be applications not installed at the mobile. In this case, the information 803 related to one or more recommended applications may be information received from an application download server. Further, the information 803 related to one or more recommended applications may become different according to a type of applications included in the folder. The controller 180 may output information about a different recommended application, according to a type of applications included in the folder. And the information may be downloaded from an external server.

At least one of the one or more recommended applications may be downloaded from an application providing server, by a user's selection. In this case, the downloaded application may be included in the folder.

In the mobile terminal according to the present invention, setting of applications included in a folder may be executable on a folder window. Hereinafter, this will be explained in more detail with reference to the attached drawings.

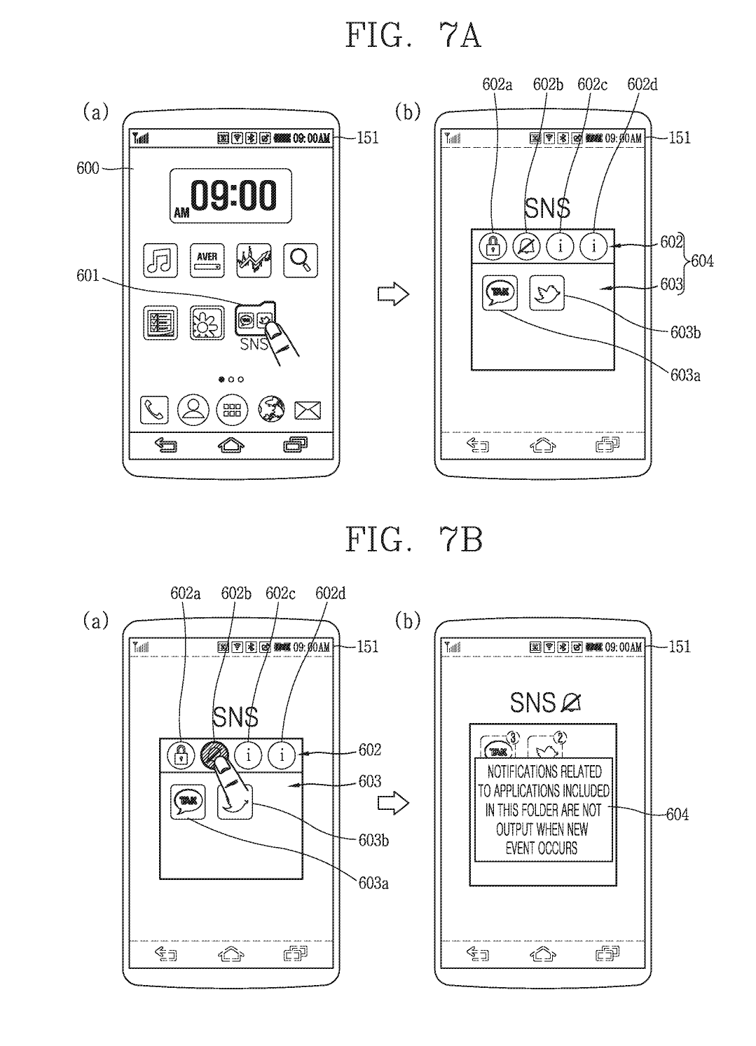

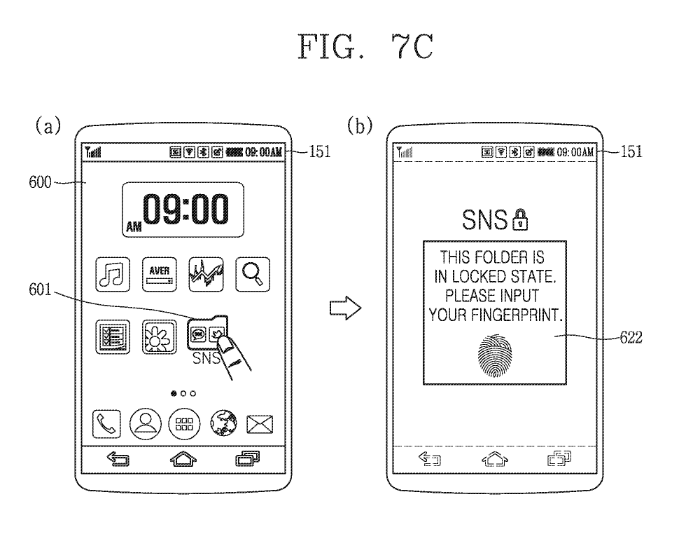

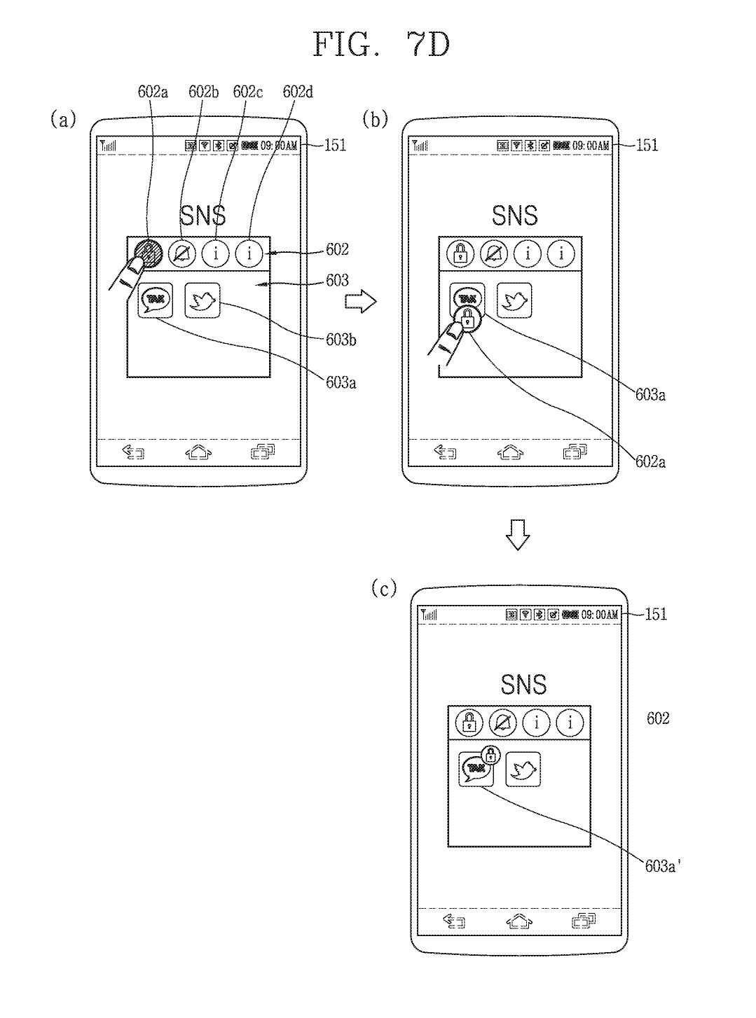

FIGS. 7A to 7D are conceptual views illustrating a method of controlling applications included in a folder, in the mobile terminal according to the present invention.

The mobile terminal according to the present invention provides a method of setting applications included in a folder on a folder window at a time, as well as a method of individually setting various application functions (e.g., a notification function, a lock function, a consent function with respect to position information provision, etc.) on applications.

For instance, if a folder image 601 is selected as shown in FIG. 7A(a), icons 603a, 603b included in the folder may be displayed as shown in FIG. 7A(b). In this case, the controller 180 may additionally output one or more setting icons 602a, 602b, 602c, 602d related to an application setting (or a function setting).

More specifically, if a first touch is applied to the folder image 601, the controller 180 may output a window 604 to at least one region of the touch screen 151. In this case, the window 604 includes a plurality of regions 602, 603. The setting icons 602a, 602b, 602c, 602d related to a function setting with respect to the applications included in the folder may be output to the one region 602, and the icons 603a, 603b of the applications included in the folder may be output to the another region 603. In case of displaying the setting icons 602a, 602b, 602c, 602d, the aforementioned embodiments may be executed in a combined manner, too.

If one of the setting icons 602a, 602b, 602c, 602d (e.g., 602b) is selected as shown in FIG. 7B(a), the controller 180 may control the applications included in the folder such that a function corresponding to the selected setting icon 602b may be reflected to all of the applications included in the folder, as shown in FIG. 7B(b). For instance, if the function corresponding to the selected setting icon is an event notification restriction function, the controller 180 may restrict an output of notification information when events are generated from the applications included in the folder.

Although not shown, if the function corresponding to the selected setting icon is an application lock function or a folder lock function, the controller 180 may execute a lock function as shown in FIG. 7C(a), such that a third party rather than an authorized user may be restricted from accessing the folder or the applications.

If the folder image 601 corresponding to the folder is selected as shown in FIG. 7C(a), the controller 180 may output guidance information 622 requiring an input of security information, in response to the selection as shown in FIG. 7C(b).

If a preset authentication process is completed as a user inputs security information, icons corresponding to the applications included in the folder may be output. In this case, the security information may be implemented in various manners. For instance, the security information may be a password, fingerprint information, face information, voice information, etc.

As aforementioned, in the mobile terminal according to the present invention, if a setting icon is selected, a function of the selected setting icon may be applied not only to all icons of applications included in a folder, but also to part of the applications. For instance, if a specific setting icon 602a shown in FIG. 7D(a) is dragged to an icon 603a of a specific application by a drag touch input as shown in FIG. 7D(b) (or if the specific setting icon 602a is dragged to the icon 603a and then the drag touch is released), the controller 180 may execute a function of the specific setting icon 602a with respect to only the specific application as shown in FIG. 7D(c). In this case, as shown in FIG. 7D(c), a new icon 603a′ of the specific application, different from the icon 603a, may be displayed such that a user may recognize the executed state (reflected state) of the function. A type of functions or settings included in a folder window may be determined or changed by a user's selection or under control of the controller.

In the mobile terminal according to the present invention, applications are selectively or entirely set through a setting icon included in a folder window. This may allow the applications to be managed efficiently.

The mobile terminal and the control method thereof according to the present invention may have the following advantages.

Firstly, when a specific folder is selected, a functional screen related to applications included in the selected specific folder may be provided. With such a configuration, a user may be provided with a desired function by merely selecting the specific folder, without selecting an icon of an application included in the specific folder in order to be provided with a function of the application. This may allow the user to check functions of the applications included in the folder more rapidly, in an intuitive manner.

Secondly, when a specific folder is selected, at least one control icon may be provided such that applications included in the specific folder may be controlled in an integrated manner. With such a configuration, a user may control applications by merely selecting a specific folder, without individually entering the applications. For instance, the user may execute a notification setting with respect to the applications, through a control icon provided with the specific folder. This may reduce a user's difficulty in directly entering the applications in order to control the applications.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

Therefore, an aspect of the detailed description is to provide a mobile terminal capable of enhancing a user's convenience by managing applications in an integrated manner using a folder, and by providing additional functions of applications included in the folder when the folder is selected, and a control method thereof.

Another aspect of the detailed description is to provide a mobile terminal capable of providing functions of applications included in a folder, to a user in a more intuitive manner, and a control method thereof.

To achieve these and other advantages and in accordance with the purpose of this specification, as embodied and broadly described herein, there is provided a mobile terminal, including: a touch screen; and a controller configured to control the mobile terminal based on a touch input applied to the touch screen, wherein the controller controls the touch screen such that at least one icon corresponding to at least one application included in a folder is displayed, in response to a first touch applied to a folder image of the folder in a state where the folder image has been displayed on the touch screen, and wherein the controller controls the touch screen such that screen information related to functions of the applications included in the folder is output, in response to a second touch applied to a predetermined region in a state where the at least one icon has been displayed.

In an embodiment, when a third touch is applied to one of the at least one icon, the controller may control the touch screen such that an execution screen of an application corresponding to the third touch-applied icon is output in the form of an entire screen.

In an embodiment, the screen information may be one of widgets provided from the applications included in the folder, graphic objects corresponding to execution screens of the applications included in the folder, information about a representative function of each of the applications included in the folder, and screen information about a common function of the applications included in the folder.

In an embodiment, if the applications included in the folder are search function-related applications, the controller may output a graphic object including a search word input region as the screen information, in response to the second touch, the controller may perform search with respect to a search word input to the search word input region by a user, through search engines corresponding to the applications included in the folder, and the controller may output a search result obtained through the search engines, to one region of the touch screen.

In an embodiment, if the first touch is applied to the folder image, the controller may control a window including the at least one icon, to be output to at least one region of the touch screen. If the second touch is applied to the output region of the window, the controller may control the screen information to be output to the touch screen.

In an embodiment, the second touch may be a drag touch starting from a first edge region of the window. The controller may output the screen information which gradually appears from the first edge region of the window along the drag touch. And the screen information may be output within the window.

In an embodiment, if a drag touch is applied to a second edge region of the window, the controller may control the touch screen such that event information about events generated from the applications included in the folder is output.

In an embodiment, the event information may be output in the form of a list. If one of items of the list is selected, the controller may output an execution screen of an application corresponding to the selected item. And the execution screen may include event information corresponding to the selected item.

In an embodiment, the second touch may be a pinch-out touch applied to the output region of the window. The controller may output a graphic object corresponding to an execution screen of each of the applications included in the folder, in response to the pinch-out touch. If a pinch-in touch is applied in the output state of the graphic object, the controller may control the graphic object to disappear.

In an embodiment, the graphic object may include information about an execution screen which has been output most recently from each of the applications included in the folder.

In an embodiment, if the first touch is applied to the folder image, the controller may output a window to at least one region of the touch screen, the window including the at least one icon and including setting icons related to a function setting with respect to the applications included in the folder. If one of the setting icons is selected, the controller may control the applications included in the folder such that a function of the selected setting icon is reflected.

In an embodiment, if the function of the selected setting icon is an event notification restriction function, the controller may restrict an output of notification information when events are generated from the applications included in the folder.

In an embodiment, even if the second touch is applied, the controller may maintain the displayed state of the at least one icon corresponding to the at least one application included in the folder.

In an embodiment, if one of the at least one icon is selected based on the second touch, in a state where the screen information related to the functions of the applications included in the folder has been output, the controller may output an execution screen of an application corresponding to the selected icon, in the form of an entire screen.

In an embodiment, if the folder is set to have a lock function, the controller may output guidance information requiring an input of security information, in response to the first touch. And if a preset authentication process is completed as the security information is input, the controller may output icons corresponding to the applications included in the folder.

To achieve these and other advantages and in accordance with the purpose of this specification, as embodied and broadly described herein, there is also provided a method of controlling a mobile terminal, the method including: displaying, on a touch screen, a folder image of a folder including at least one application; displaying at least one icon corresponding to the at least one application included in the folder, in response to a first touch applied to the folder image in a state where the folder image has been displayed on the touch screen; and controlling the touch screen such that screen information related to functions of the applications included in the folder is output, in response to a second touch applied to a predetermined region in a state where the at least one icon has been displayed.

In an embodiment, the screen information may be one of widgets provided from the applications included in the folder, graphic objects corresponding to execution screens of the applications included in the folder, information about a representative function of each of the applications included in the folder, and screen information about a common function of the applications included in the folder.

In an embodiment, the method may further include: if the applications included in the folder are search function-related applications, outputting a graphic object including a search word input region as the screen information, in response to the second touch; performing search with respect to a search word input to the search word input region, through search engines corresponding to the applications included in the folder; and outputting a search result obtained through the search engines, to one region of the touch screen.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal, comprising:
a touch screen; and
a controller configured to control the mobile terminal based on a touch input applied to the touch screen,
wherein the controller controls the touch screen to:
display a folder image for a folder that includes at least one icon corresponding to at least one application,
display the at least one icon included in the folder in response to a first touch applied to the folder image, and
display an object related to a function of an application included in the folder in response to a second touch on the touch screen, the second touch being applied to a predetermined region of the touch screen in a state where the at least one icon has been displayed.

2. The mobile terminal of claim 1, wherein when a third touch is applied to one of the at least one icon, the controller controls the touch screen to display an execution screen of an application corresponding to the icon selected with the third touch in the form of an entire screen view.

3. The mobile terminal of claim 1, wherein the object related to a function of an application included in the folder is one of a widget provided for a corresponding application included in the folder, a graphic object corresponding to an execution screen of the corresponding application included in the folder, information about a representative function of the corresponding application included in the folder, or screen information about a common function of more than one applications included in the folder.

4. The mobile terminal of claim 3, wherein when an application included in the folder is a search function-related application, the controller outputs a graphic object including a search word input region as the object in response to the second touch, the controller performs a search with respect to a search word input to the search word input region through search engines corresponding to the search function-related application included in the folder, and the controller outputs a search result obtained through the search engines to one region of the touch screen.

5. The mobile terminal of claim 1, wherein when the first touch is applied to the folder image, the controller outputs a window including the at least one icon to be displayed in a prescribed region of the touch screen, and
wherein when the second touch is applied to the window, the controller controls the object to be displayed on the touch screen.

6. The mobile terminal of claim 5, wherein the second touch is a drag touch starting from a first edge region of the window,
wherein the controller outputs the object for each application which gradually appears from the first edge region of the window along the drag touch, and
wherein the object is displayed within the window including the at least one icon.

7. The mobile terminal of claim 6, wherein when a drag touch is applied to a second edge region of the window, the controller controls the touch screen such that event information about events generated from the applications included in the folder is output.

8. The mobile terminal of claim 7, wherein the event information is output in the form of a list,
wherein when one of items of the list is selected, the controller outputs an execution screen of an application corresponding to the selected item, and
wherein the execution screen includes event information corresponding to the selected item.

9. The mobile terminal of claim 5, wherein the second touch is a pinch-out touch applied to the window,
wherein the controller outputs a graphic object corresponding to an execution screen of each of the applications included in the folder to be displayed in response to the pinch-out touch, and
wherein when a pinch-in touch is applied while the graphic object is displayed, the controller controls the graphic object to disappear.

10. The mobile terminal of claim 9, wherein the graphic object includes information about an execution screen which has been output most recently from each of the applications included in the folder.

11. The mobile terminal of claim 1, wherein when the first touch is applied to the folder image, the controller outputs a window to be displayed in a prescribed region of the touch screen, the window including the at least one icon and including setting icons related to function setting with respect to the applications included in the folder, and
wherein when one of the setting icons is selected, the controller controls the applications included in the folder such that a function of the selected setting icon is accessed.

12. The mobile terminal of claim 11, wherein when the function of the selected setting icon is an event notification restriction function, the controller restricts an output of notification information when events are generated from the applications included in the folder.

13. The mobile terminal of claim 1, wherein even when the second touch is applied, the controller maintains the displayed state of the at least one icon corresponding to the at least one application included in the folder.

14. The mobile terminal of claim 13, wherein when one of the at least one icon is selected in a state where the object related to the functions of the applications included in the folder has been output, the controller outputs an execution screen of an application corresponding to the selected icon to be displayed on the touch screen in the form of an entire screen view.

15. The mobile terminal of claim 1, wherein when the folder is set to have a lock function, the controller outputs guidance information requiring an input of security information in response to the first touch, and
wherein when a preset authentication process is completed as the security information is input, the controller outputs the at least one icons corresponding to the applications included in the folder to be displayed.

16. A method of controlling a mobile terminal, comprising:
displaying, on a touch screen, a folder image of a folder that includes at least one icon for at least one application;
in response to a first touch applied to the folder image, opening the folder and displaying at least one icon corresponding to the at least one application included in the folder; and
in response to a second touch on the touch screen, controlling the touch screen, by a processor, to display an object related to a function of an application included in the folder, the second touch being sensed in a predetermined region of the touch screen in a state where the at least one icon has been displayed.

17. The method of claim 16, wherein the object related to a function of an application included in the folder is one of a widget provided for a corresponding application included in the folder, a graphic object corresponding to an execution screens of the corresponding application included in the folder, information about a representative function of the corresponding application included in the folder, or screen information about a common function of more than one applications included in the folder.

18. The method of claim 17, further comprising:
when an application included in the folder is a search function-related application, outputting a graphic object including a search word input region as the object in response to the second touch;
performing a search with respect to a search word input to the search word input region through search engines corresponding to the search function-related application included in the folder; and
outputting a search result obtained through the search engines to one region of the touch screen.

19. The method of claim 16, wherein, in response to the first touch on the folder image, the folder is opened in a window at a prescribed region of the touch screen, the window including the at least one icon for each application included in the folder.

20. The method of claim 16, wherein, in response to the second touch, the object related to a function of each application included in the folder is displayed together with the at least one icon for each application included in the folder.
